(19) United States
(12) Patent Application Publication
(10) Pub. No.: US 2013/0185193 A1
(43) Pub. Date: Jul. 18, 2013

(54) FRAUD MINIMIZATION AND ANALYTICS THROUGH GEOSPATIAL COMPARISON OF VEHICLE LOCATION AND TRANSACTION SITUS

(71) Applicants: BRIAN BOLING, Knoxville, TN (US); Steve Gertz, Smyrna, GA (US); Brad Jarvis, Newport Beach, CA (US); Richard Pearlman, Carlsbad, CA (US)

(72) Inventors: BRIAN BOLING, Knoxville, TN (US); Steve Gertz, Smyrna, GA (US); Brad Jarvis, Newport Beach, CA (US); Richard Pearlman, Carlsbad, CA (US)

(73) Assignee: Spireon, Inc., Knoxville, TN (US)

(21) Appl. No.: 13/552,677

(22) Filed: Jul. 19, 2012

Related U.S. Application Data
(63) Continuation-in-part of application No. 13/310,629, filed on Dec. 2, 2011.
Application No. 13/310,629 is a continuation-in-part of application No. 13/328,070, filed on Dec. 16, 2011.
Application No. 13/328,070 is a continuation-in-part of application No. 13/421,571, filed on Mar. 15, 2012.

(51) Int. Cl. G06Q 20/32

(52) U.S. Cl. CPC G06Q 20/3224
USPC 705/39

(57) ABSTRACT

A method comprising determining that a transaction associated with a purchase of a fuel of a vehicle equipped with a geospatial positioning device is associated with a unique identifier of a fuel card is disclosed. The method may comprise comparing a present geospatial location of the vehicle with a situs where the transaction associated with the purchase of the fuel of the vehicle is determined when a distance between the vehicle and the situs where the transaction associated with the purchase of the fuel of the vehicle occurs is within a threshold limit. The method may also comprise generating an alert communication to a party based on a transgression of the vehicle from the threshold limit.

### CLAIM OF PRIORITY

This utility patent application is a Continuation-In-Part (CIP) of and incorporates by references in its entirety,
United States Utility patent application Ser. No. 13/310,629 titled “ALERT GENERATION BASED ON A GEOGRAPHIC TRANSGRESSION OF A VEHICLE” and filed on Dec. 2, 2011;
United States Utility patent application Ser. No. 13/328,070 titled “GEOSPATIAL DATA BASED MEASUREMENT OF RISK ASSOCIATED WITH A VEHICULAR SECURITY INTEREST IN A VEHICULAR LOAN PORTFOLIO” and filed on Dec. 16, 2011; and
United States Utility patent application Ser. No. 13/421,571 titled “GEOSPATIAL DATA BASED ASSESSMENT OF DRIVER BEHAVIOR” and filed on Mar. 15, 2012.

### FIELD OF TECHNOLOGY

This disclosure relates generally to fraud minimization and analytics through geospatial comparison of vehicle location and transaction situs. A transaction associated with purchase of fuel of a vehicle equipped with a geospatial positioning device may be associated with a unique identifier of a fuel card and may be compared to a present geospatial location of the vehicle within a situs where the transaction associated with the purchase of the fuel of the vehicle occurs.

### BACKGROUND

Fuel Cards issued to drivers and/or operators of vehicles may be a convenient method to track, monitor and improve driver behavior as it pertains to vehicle fuel usage and consumption. Fuel cards are routinely issued to drivers of fleet vehicles who then use the fuel card at one or more fueling locations along their planned route of travel. Information gleaned from fuel usage and consumption derived from the fuel card may provide useable information and data to the provider of the fuel card and/or any other interested party.

Integration of fuel card billing data and global positioning system (“GPS”) based fleet tracking information may provide both predictive and post-event driver and vehicle performance analytics data. Combining fuel card data and GPS data gleaned from the vehicle itself may enable a provider of fuel cards and/or a fleet management company to estimate fuel efficiency of their drivers, prevent excessive idling during fueling, validate fueling transactions, prevent fraud, and predict when a vehicle may require fuel, among other benefits. An “in-network” fueling facility may also be determined and this information may be transmitted to drivers of vehicles for better cost-savings by utilizing discounts, benefits, facilities and other services that may be associated with and complementary to a fuel card and their corresponding “in-network” fueling facilities.

Because of the high cost of fuel, providers of fuel cards may be concerned about fraud and unauthorized uses of fuel cards, especially if they have to monitor and track the usage of hundreds if not thousands of fuel card transactions. Excessive, fraudulent and/or inefficient use of fuel may cost a company (e.g., a fleet management company) thousands of dollars in lost revenue and cost savings. On the contrary, authorized, efficient and proportionate use of fuel may save a company thousands of dollars. It may also contribute to efficient operation and management of a large fleet of vehicles and may promote positive changes in driver behavior.

### SUMMARY

A method of determining that a transaction associated with a purchase of a fuel of a vehicle equipped with a geospatial positioning device is associated with a unique identifier of a fuel card and comparing a present geospatial location of the vehicle (e.g., vehicle situs) with a situs where the transaction associated with the purchase of the fuel of the vehicle occurs (i.e., transaction situs) is disclosed.

In another aspect, the comparison of the present geospatial location of the vehicle with the situs where the transaction associated with the purchase of the fuel of the vehicle occurs is determined when a distance between the vehicle and the situs where the transaction associated with the purchase of the fuel of the vehicle occurs is within a threshold limit and when the distance between the vehicle and the situs where the transaction associated with the purchase of the fuel of the vehicle is outside the threshold limit. An alert communication is generated and/or transmitted to a party based on a transgression of the vehicle from the threshold limit.

The method may also comprise associating the fuel card with a driver of the vehicle and/or the vehicle equipped with the geospatial positioning device and currently having the situs within the present geospatial location. An authorized use of the fuel card may be verified upon initiation of the transaction associated with the purchase of the fuel of the vehicle. An alert communication may be generated and/or transmitted to the party if the transaction associated with the purchase of a fuel of the vehicle is not the authorized. In one aspect, geospatial data received from the vehicle equipped with the geospatial positioning device may be analyzed to locate the situs of the vehicle within the present geospatial location (e.g., vehicle situs).

According to another aspect, the method may comprise associating a fuel card with a vehicle equipped with a geospatial positioning device and currently having a situs within a present geospatial location. It may also comprise receiving geospatial data from the geospatial positioning device indicative of the present geospatial location of the vehicle upon use of the fuel card at a fueling facility within the present geospatial location. Another aspect may comprise determining the quantity of fuel purchased with the fuel card at the fueling facility within the present geospatial location and/or the mileage driven by the vehicle since a last fueling such that a preferred fueling facility may be determinable based on a future geospatial location of the vehicle. An alert communication to a party comprising the preferred fueling location based on a future geospatial location of the vehicle and/or a planned route associable with the vehicle may also be generated.

The invention may also comprise a system with one or more modules. For example, it may comprise an association module to associate a fuel card with a vehicle equipped with a geospatial positioning device and currently having a situs within a present geospatial location. A geospatial data module may receive geospatial data from the geospatial positioning device indicative of a situs of the vehicle upon use of the fuel card at a fueling facility within the present geospatial location.

In addition, a fuel module may determine the quantity of fuel purchased with the fuel card at the fueling facility within the present geospatial location and/or the mileage driven by the vehicle since a last fueling such that a preferred fueling facility is determinable based on a future geospatial location of the vehicle. A communication module may generate an alert communication to a party comprising the preferred fueling facility based on the future geospatial location of the vehicle.

According to another aspect, the method may comprise permitting a provider of a fuel card access to geospatial data indicative of a situs of a vehicle associable with the fuel card within a geospatial location through a geospatial positioning device inside the vehicle upon use of the fuel card at a fueling facility. The method may also comprise utilizing data link from a base terminal communicatively coupled to the geospatial positioning device such that the geospatial data indicative of a situs of the vehicle associable with the fuel card within the geospatial location is transmitted from the geospatial positioning device to the base terminal via the data link.

Another aspect may comprise determining the quantity of fuel purchased with the fuel card at the fueling facility within the geospatial location and/or the mileage driven by the vehicle since a last fueling such that a preferred fueling facility is determinable based on a future geospatial location of the vehicle. An alert communication to a party comprising the preferred fueling facility based on at least one of the future geospatial location of the vehicle and a planned route associable with the vehicle is also generated.

The methods and systems disclosed herein may be implemented by any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1A illustrates associating a fuel transaction with a unique identifier of a fuel card, according to one or more embodiments.

FIG. 1B illustrates the distance between the vehicle and the situs where the transaction associated with the purchase of the fuel of the vehicle occurs (i.e., the transaction situs) with respect to the threshold limit, according to one or more embodiments.

FIG. 1C illustrates the generation and transmission of an alert communication a party if the distance between the vehicle situs and transaction situs exceeds the threshold limit, according to one or more embodiments.

FIGS. 2A, 2B, 2C, and 2D illustrate the determination of whether or not a fueling transaction is an authorized use by comparison of the vehicle situs and the transaction situs, according to one or more embodiments.

FIGS. 3A and 3B illustrate determining and generating an alert communication indicative of a preferred fueling location based on a future geospatial location of the vehicle, according to one or more embodiments.

FIGS. 4A and 4B illustrate one or more types of telemetry data that may be gathered from the geospatial positioning device in a vehicle for analysis and implementation in one or more methods, according to one or more embodiments.

FIG. 5 is a table view of determining and validating authorized use of the fuel card for a fueling transaction of the vehicle based on the transaction situs and the vehicle situs, according to one or more embodiments.

FIG. 6 illustrates one or more types of preferred fueling facilities, according to one or more embodiments.

FIG. 7 is a module view wherein any of the methods and systems described herein may be implemented and/or performed, according to one or more embodiments.

FIG. 8 is a flow chart that illustrates the generation and transmission of an alert communication a party if the distance between the vehicle situs and transaction situs exceeds the threshold limit, according to one or more embodiments.

FIG. 9 is a flow chart that illustrates determining and generating an alert communication indicative of a preferred fueling location based on a future geospatial location of the vehicle, according to one or more embodiments.

FIG. 10 is a flow chart that illustrates utilizing a data link to determine a quantity of fuel purchased such that a preferred fueling location may be communicated to the driver of the vehicle based on the vehicle's future geospatial location, according to one or more embodiments.

FIG. 11 is a network view, according to one or more embodiments.

FIG. 12 is a diagrammatic view of a data processing system in which any of the embodiments disclosed herein may be performed, according to one or more embodiments.

Other features of the present embodiments will be apparent from the accompanying drawings and from the detailed description that follows.

### DETAILED DISCLOSURE

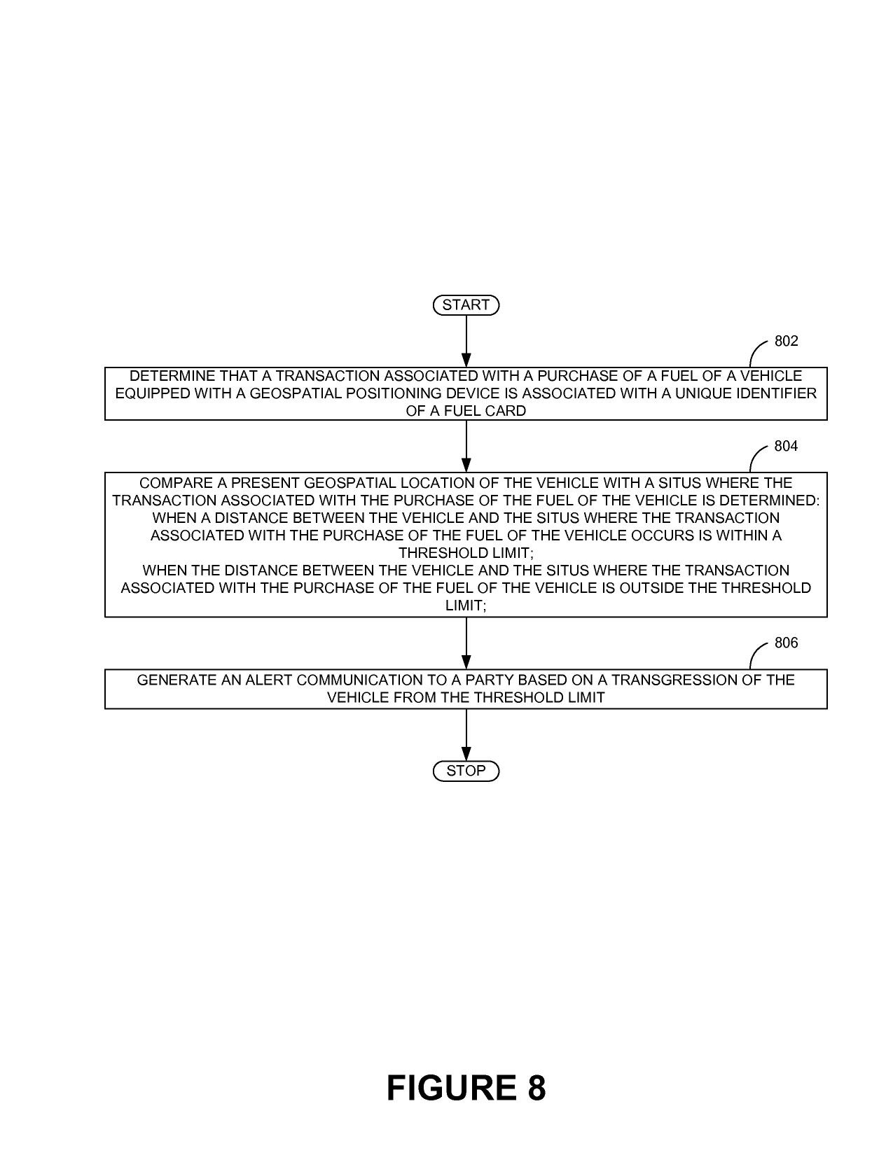

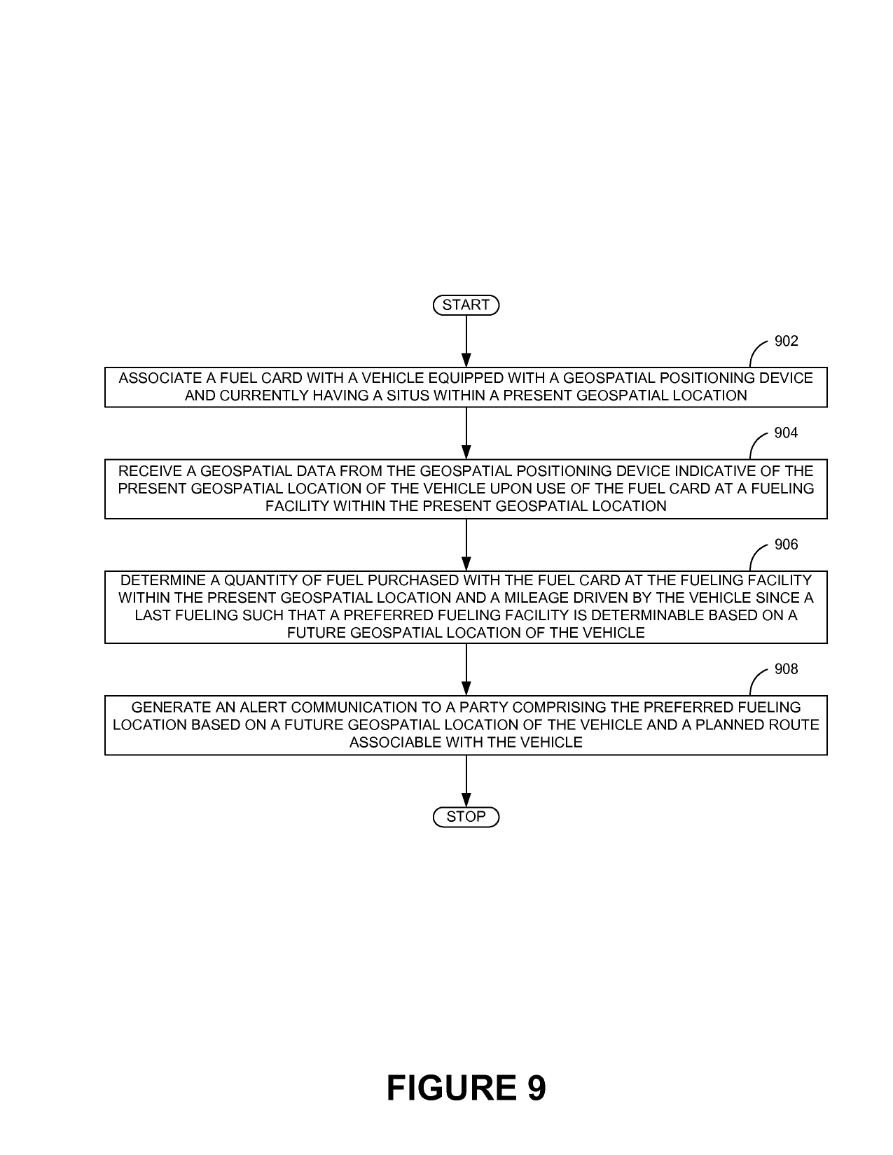

According to one or more exemplary embodiments, a method comprising determining that a transaction associated with a purchase of a fuel of a vehicle 106 equipped with a geospatial positioning device 108 is associated with a unique identifier 104 of a fuel card 102 is disclosed. The method may comprise comparing a present geospatial location 114 of the vehicle 106 with a situs where the transaction associated with the purchase of the fuel of the vehicle 106 is determined (e.g., transaction situs 110) when a distance 116 between the vehicle 106 (e.g., vehicle situs 202) and the situs where the transaction associated with the purchase of the fuel of the vehicle occurs (e.g., transaction situs 110) is within a threshold limit 112, according to one or more embodiments (see FIG. 8 and FIG. 9).

According to an illustrative example, interested parties may use and/or employ a fuel card 102 tied to and/or associated with a geospatial positioning device 108 that may communicate geospatial data 302 based on a worldwide navigational and surveying facility dependent on the reception of signals from an array of orbiting satellites (e.g., GPS technology). Another device may be a Real Time Locator System (RTLS) which may use Radio Frequency Identification (RFID) technology to transmit the physical location of RFID tagged objects. In addition, and according to other embodiments, such geospatial positioning devices may be placed directly within a vehicle 106 by Original Equipment Manufacturers (OEMs). For example, car manufacturers may install OEM telematics solutions (e.g., OnStar™) within all their vehicles 106 A-N. In addition, fuel cards 102 A-N provided to and/or made available to drivers 204 A-N may be a credit card, a proprietary fuel card, or any other type of card and/or method that may enable drivers to pay for fuel at one or more fueling facilities (e.g., transaction situs 110).

Therefore, the use of GPS, RTLS, RFID or OEM telematics based geospatial positioning device 108 to enable the gathering of telemetry data may be combined with data derived from fuel card 102's usage to enable a party 120 to effectively monitor and track one or more vehicles and drivers, according to one or more embodiments. Geospatial positioning devices may be used to track and gather telemetry data associated with the vehicle 106. Certain fueling locations, driving behaviors and/or patterns of movement associated with the driver and his/her vehicle 106 may be indicative of an increased or decreased risk of fraud and unauthorized use related to fuel purchase and usage. Gathering such data which may be a combination of GPS telemetry data and fuel card data may be indicative of a driver and/or vehicle's fuel purchase and subsequent consumption and may be useful to improve the cost savings and/or fuel efficiency of the driver and/or vehicle and/or a fleet of drivers and/or vehicles, according to one or more embodiments.

It will be appreciated that the method may comprise comparing the present geospatial location 114 of the vehicle 106 with a situs where the transaction associated with the purchase of the fuel of the vehicle is determined (e.g., transaction situs 110) when the distance 116 between the vehicle 106 and the situs where the transaction associated with the purchase of the fuel of the vehicle (e.g., transaction situs 110) is outside the threshold limit 112, according to one illustrative example. According to another exemplary embodiment, the method may also comprise generating an alert communication 118 to a party based on a transgression of the vehicle from the threshold limit 112 (see FIG. 8 and FIG. 9).

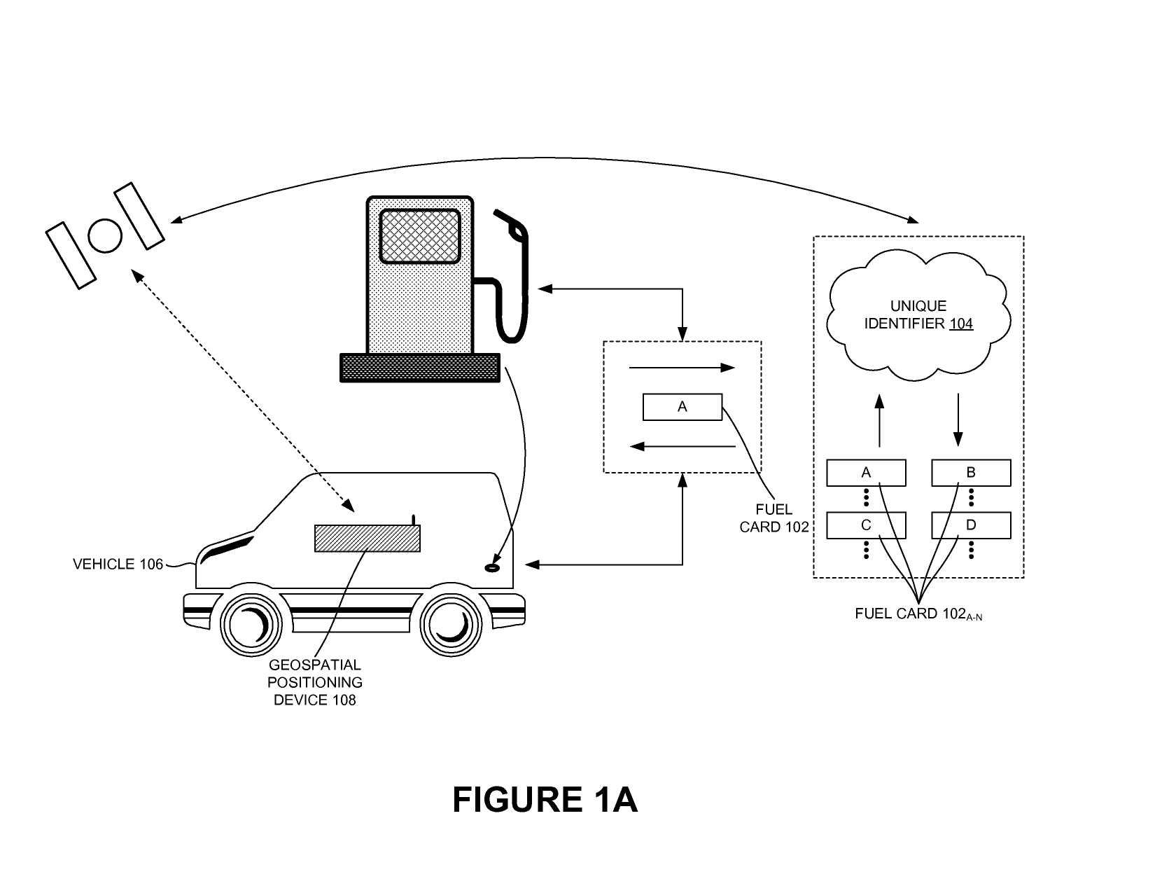

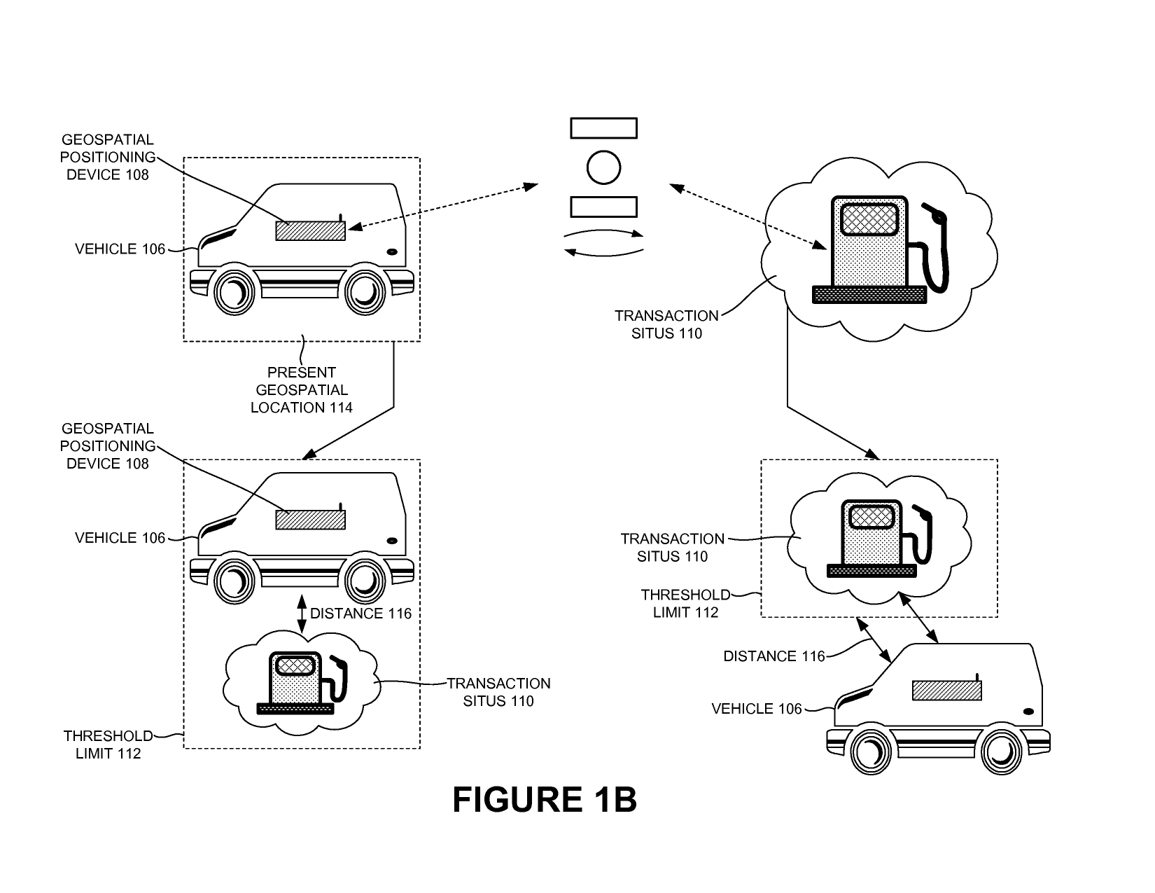

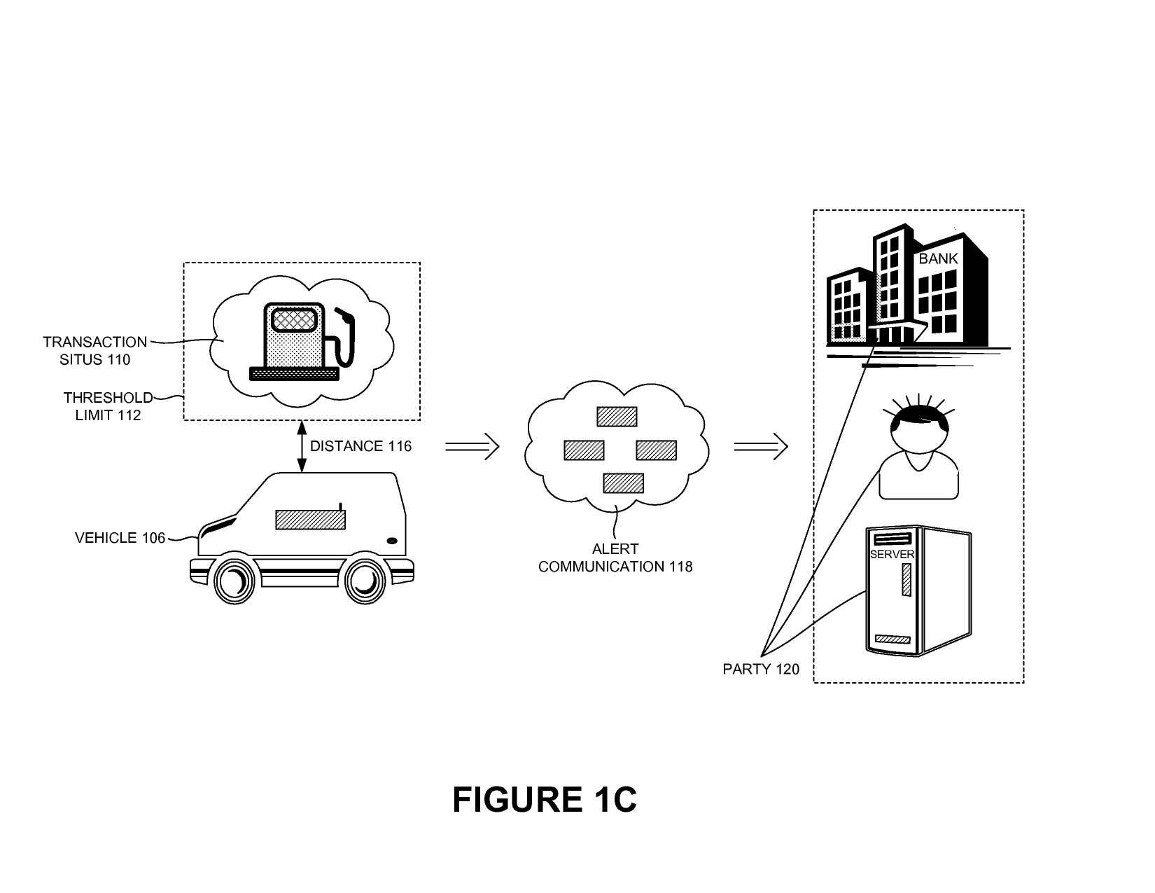

FIG. 1A illustrates associating a fuel transaction with a unique identifier 104 of a fuel card 102, according to one or more embodiments. The unique identifier 104 may be associated with one or more fuel cards 102 A-N. A geospatial positioning device 108 present inside vehicle 106 may be utilized to make the association between vehicle 106 and/or the driver 204 of vehicle 106 with the unique identifier 104. Multiple fuel cards 102 A-N may be associable with a single unique identifier 104 and vice-versa. A single fuel card 102A may be associable with vehicle 106 such that a fueling transaction may be monitored, according to one embodiment.

FIG. 1B illustrates the distance 116 between the vehicle 106 and the situs where the transaction associated with the purchase of the fuel of the vehicle 106 occurs (i.e., the transaction situs 110) with respect to the threshold limit 112, according to one or more embodiments. Vehicle 106 may be within the threshold limit 112, or may be outside the threshold limit 112. The transaction situs 110 may determine if vehicle 106 is within the threshold limit 112 based on the present geospatial location 114 of vehicle 106 (e.g., vehicle 106's situs) in comparison (e.g., distance 116) to the transaction situs 110, according to one or more embodiments. The fuel card 102 may be used to determine the transaction situs 110 upon use of the fuel cars 102 at a fueling location that is the transaction situs 110, according to another embodiment.

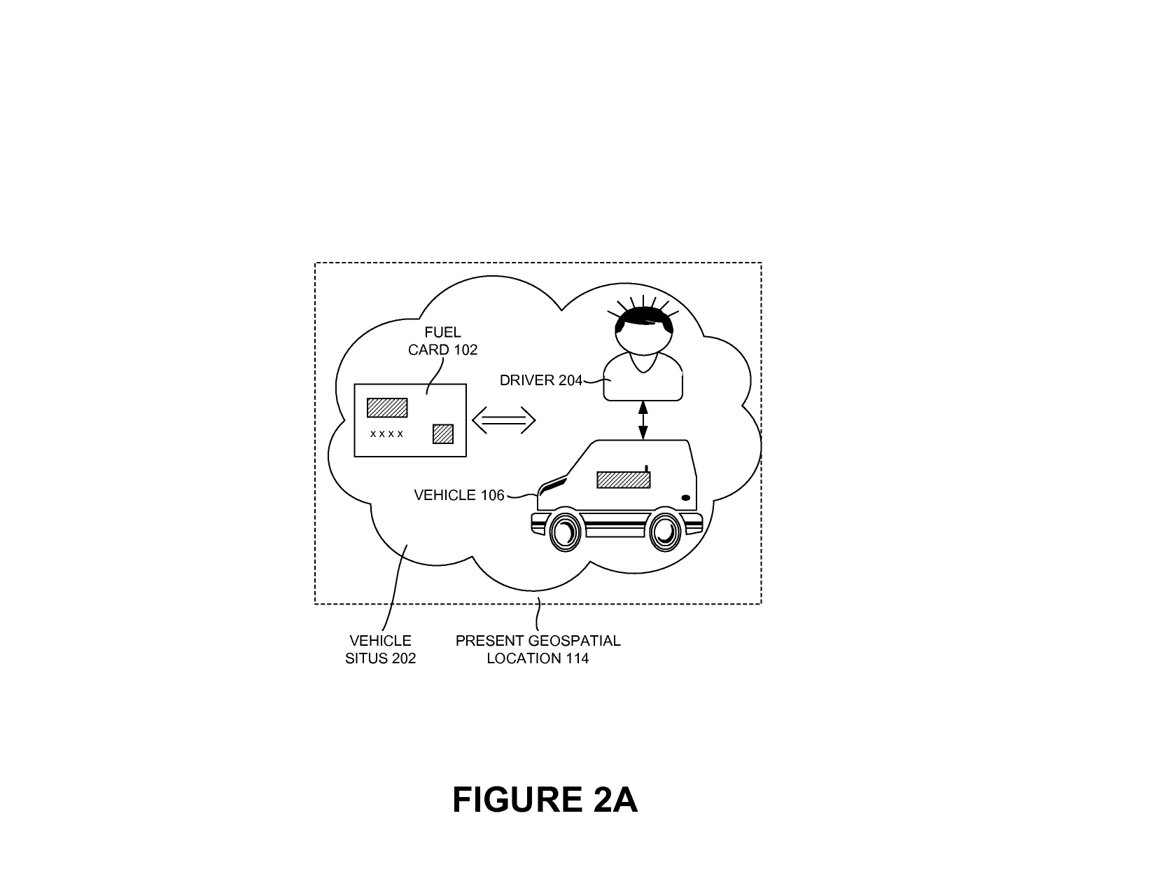

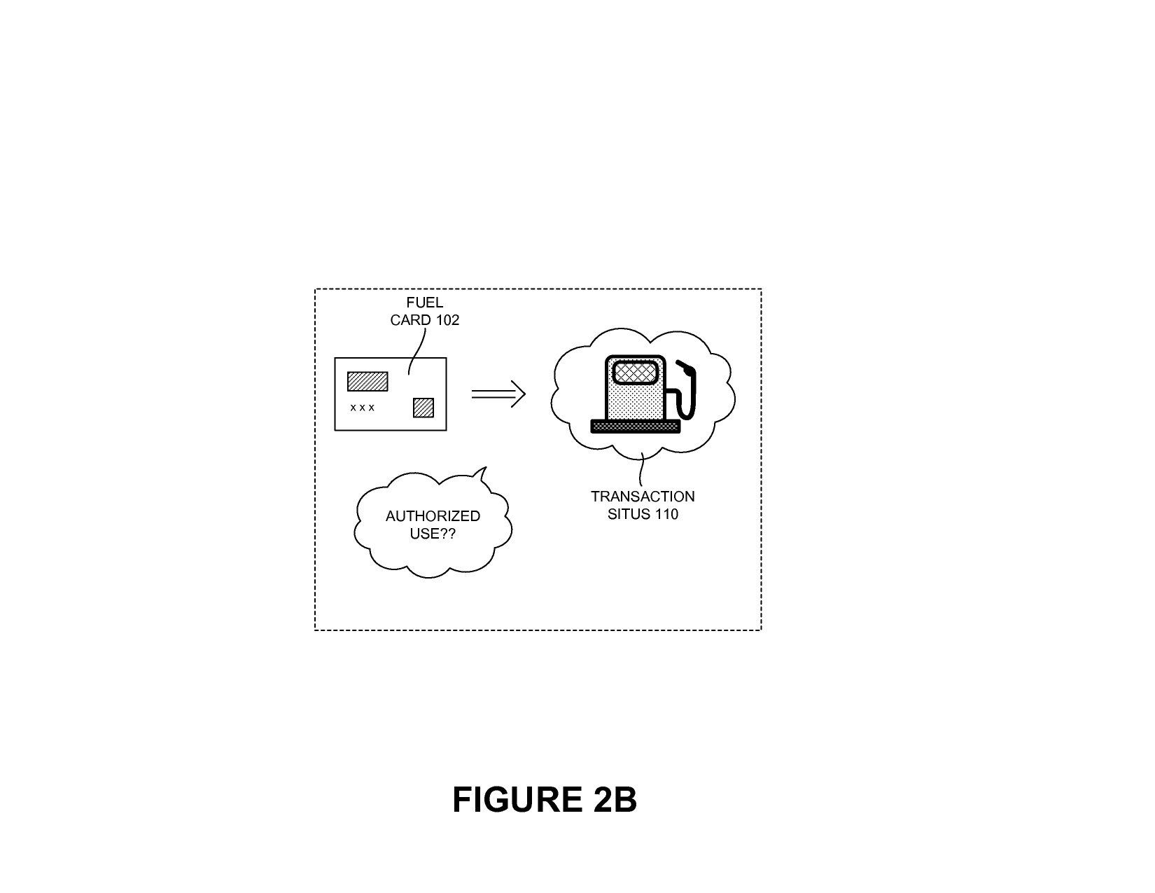

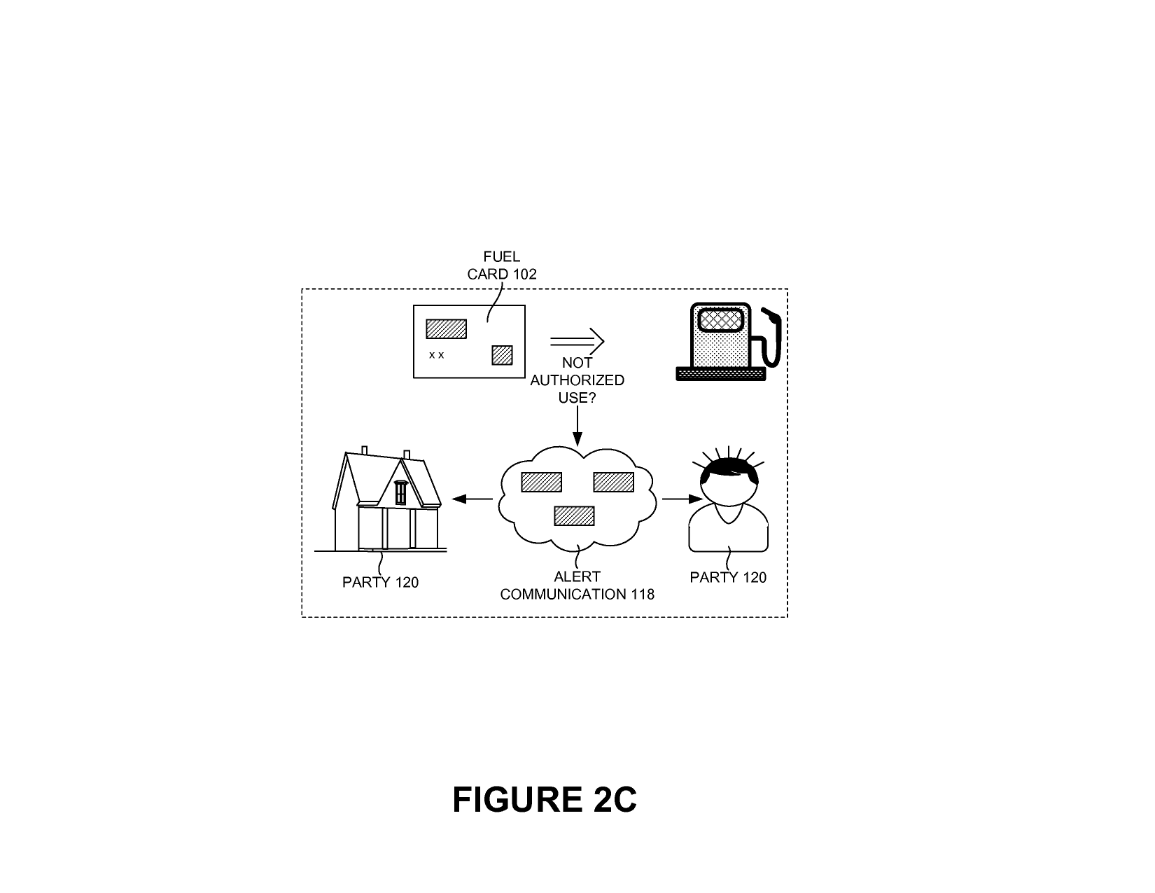

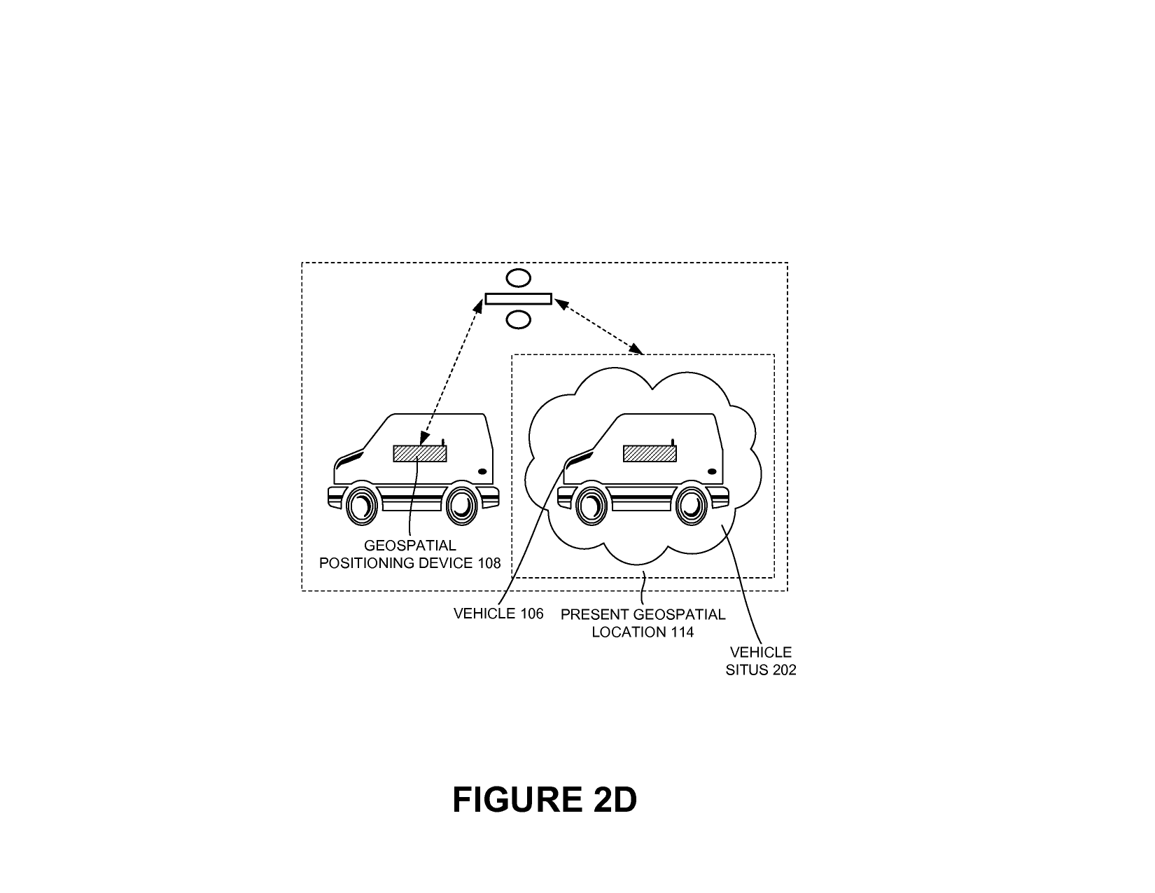

FIG. 1C illustrates the generation and transmission of an alert communication 118 to a party 120 if the distance 116 between the vehicle situs 202 (e.g., present geospatial location 114 of vehicle 106) (see also FIG. 2A) and transaction situs 110 exceeds the threshold limit 112, according to one or more embodiments. Party 120, according to one or more embodiments, may be a bank, a credit card company, a finance company, a fleet management company, a GPS device manufacturer, an automobile insurance company, a government, and/or any other type of institution and/or organization.

Alert communication 118 may be any form of verbal, written, and/or electronic communication to party 120 including but not limited to telephone, facsimile, electronic mail, short message system (“SMS”), data communication to an on-board navigation system, etc., according to one or more illustrative examples. The transaction situs 110 may or may not be a fueling location and may just be any location where fuel card 102 is used to perform one or more financial transactions, according to one or more embodiments.

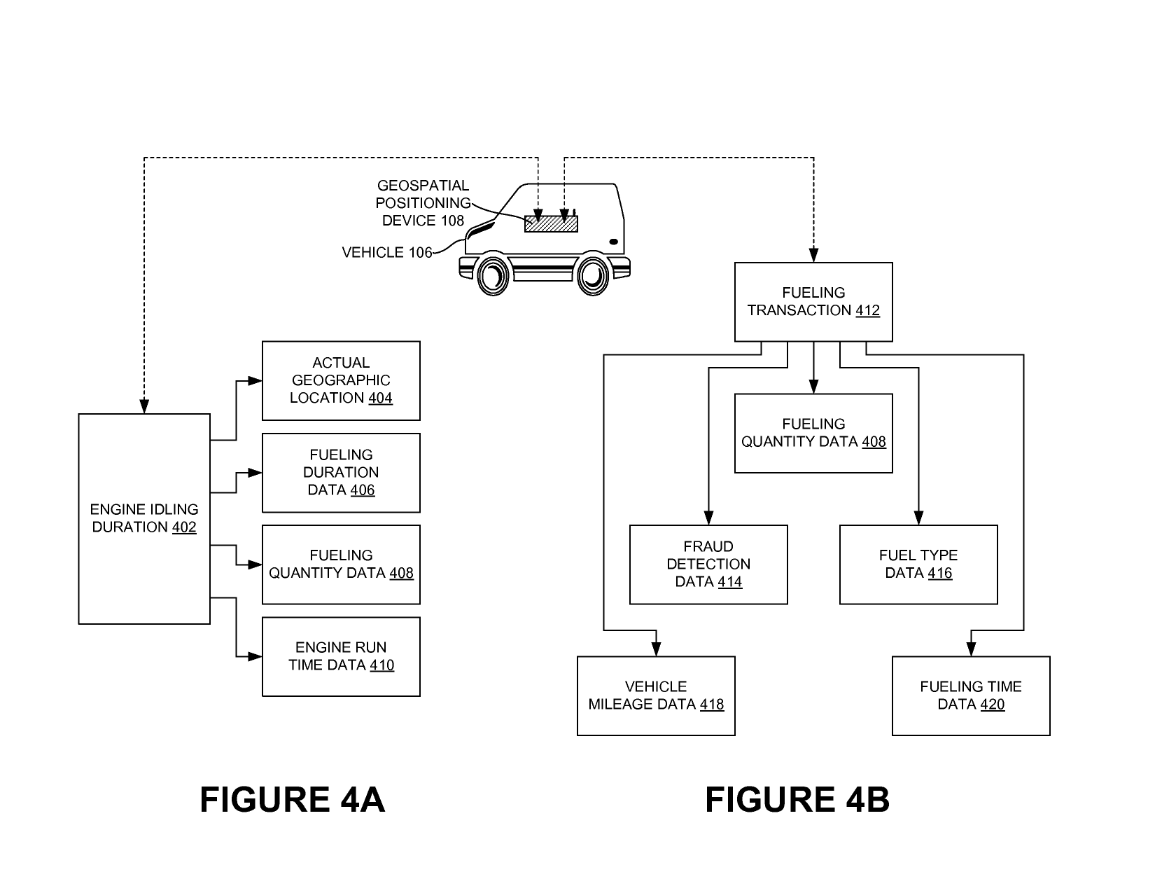

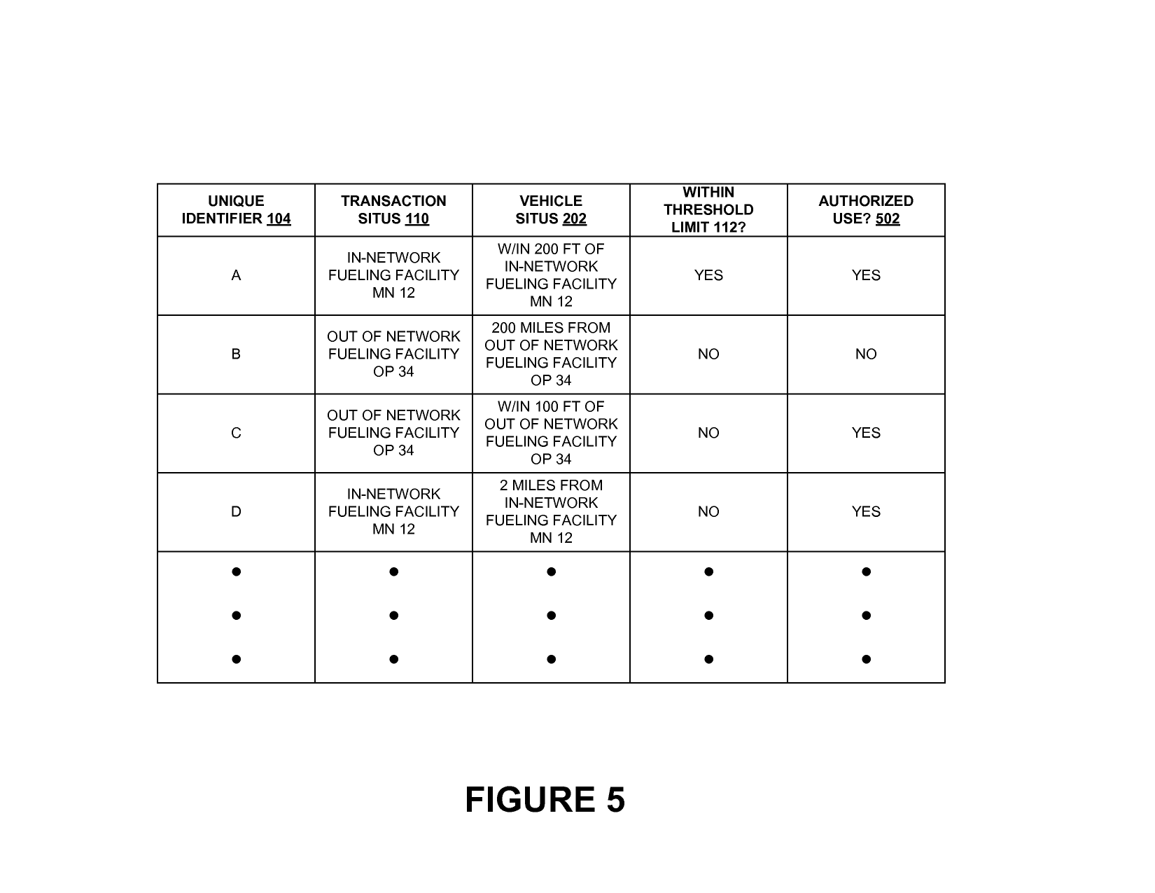

FIGS. 2A, 2B, 2C and 2D illustrate the determination of whether or not a fueling transaction 412 (see FIG. 4B) is an authorized use 502 (see FIG. 5) by comparison of the vehicle situs 202 and the transaction situs 110, according to one or more embodiments. For example, FIG. 2A shows the association of fuel card 102 with driver 204 and/or vehicle 106. Vehicle 106 may have a vehicle situs 202 which may be located in a present geospatial location 114. The vehicle situs 202, according to one embodiment, may be smaller or larger in area compared to the present geospatial location 114. FIG. 2B illustrates determining whether the use of fuel card 102 at a transaction situs 110 (which may also be a fueling location) is an authorized use 502 (see FIG. 5), according to one or more embodiments.

FIGS. 2C and 2D illustrate the comparison between the vehicle situs 202 and the transaction situs 110 by utilizing the geospatial positioning device 108 in vehicle 106. According to one or more embodiments, a use of the fuel card 102 is deemed an authorized use 502 if the distance 116 between the vehicle situs 202 and the transaction situs 110 is within a threshold limit 112. If the distance 116 is greater than the threshold limit 112, it may be deemed that an unauthorized use of the fuel card 102 has occurred and an alert communication 118 may be generated and subsequently transmitted to party 120 (see FIG. 2C), according to one or more embodiments.

It will be appreciated that, according to one or more embodiments, fuel card 102 may be associated with a driver 204 (see FIG. 2A) of vehicle 106 and/or vehicle 106 equipped with the geospatial positioning device 108 and currently having the situs within the present geospatial location 114 (e.g., vehicle situs 202) (see FIG. 2A). An authorized use 502 of the fuel card 102 may be verified upon initiation of the transaction associated with the purchase of the fuel of the vehicle 106 (e.g., upon initiation of fueling transaction 412 at transaction situs 110). An alert communication 118 may be generated to party 120 if the transaction associated with the purchase of a fuel of the vehicle (e.g., fueling transaction 412 at transaction situs 110) is not an authorized use 502 and/or determined not to be an authorized use 502, according to one or more embodiments. According to another embodiment, geospatial data 302 received from vehicle 106 equipped with the geospatial positioning device 108 may be analyzed and may be used to locate the situs of the vehicle (e.g., vehicle situs 202) within the present geospatial location 114.

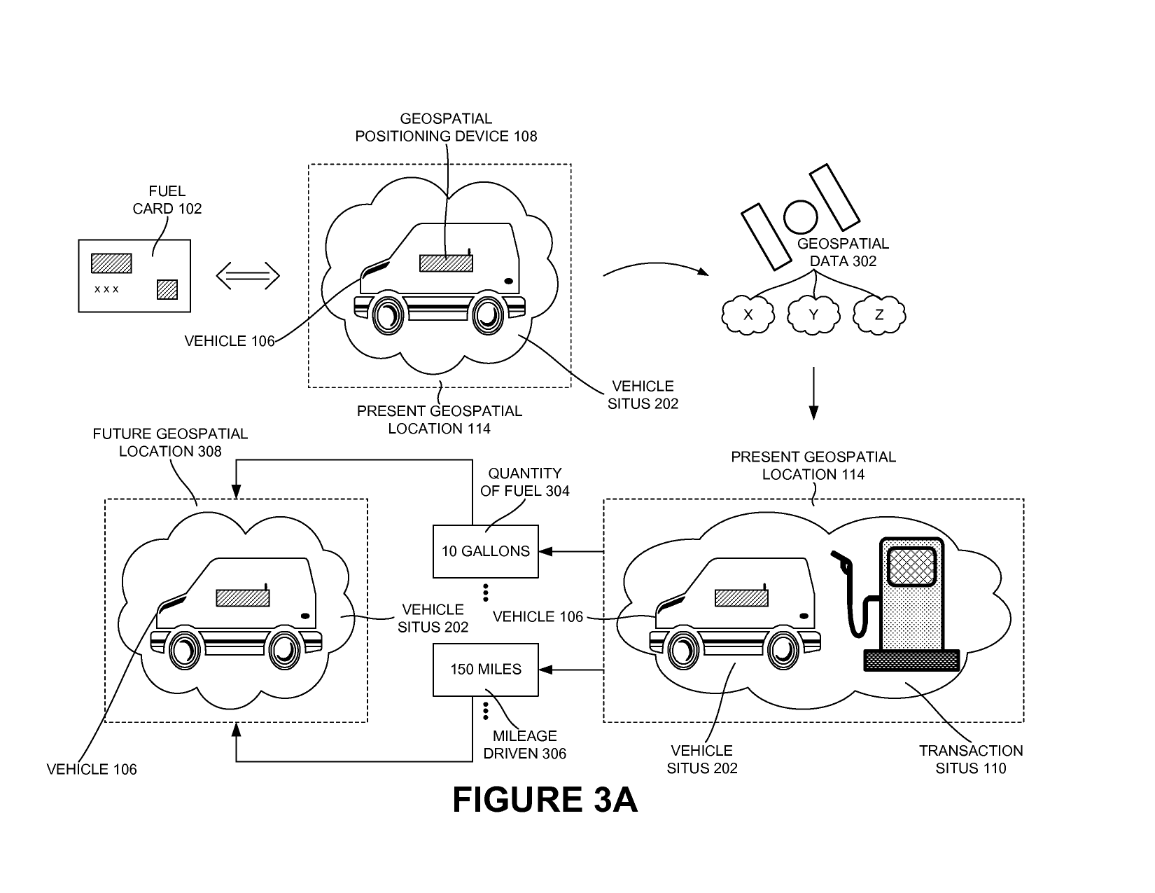

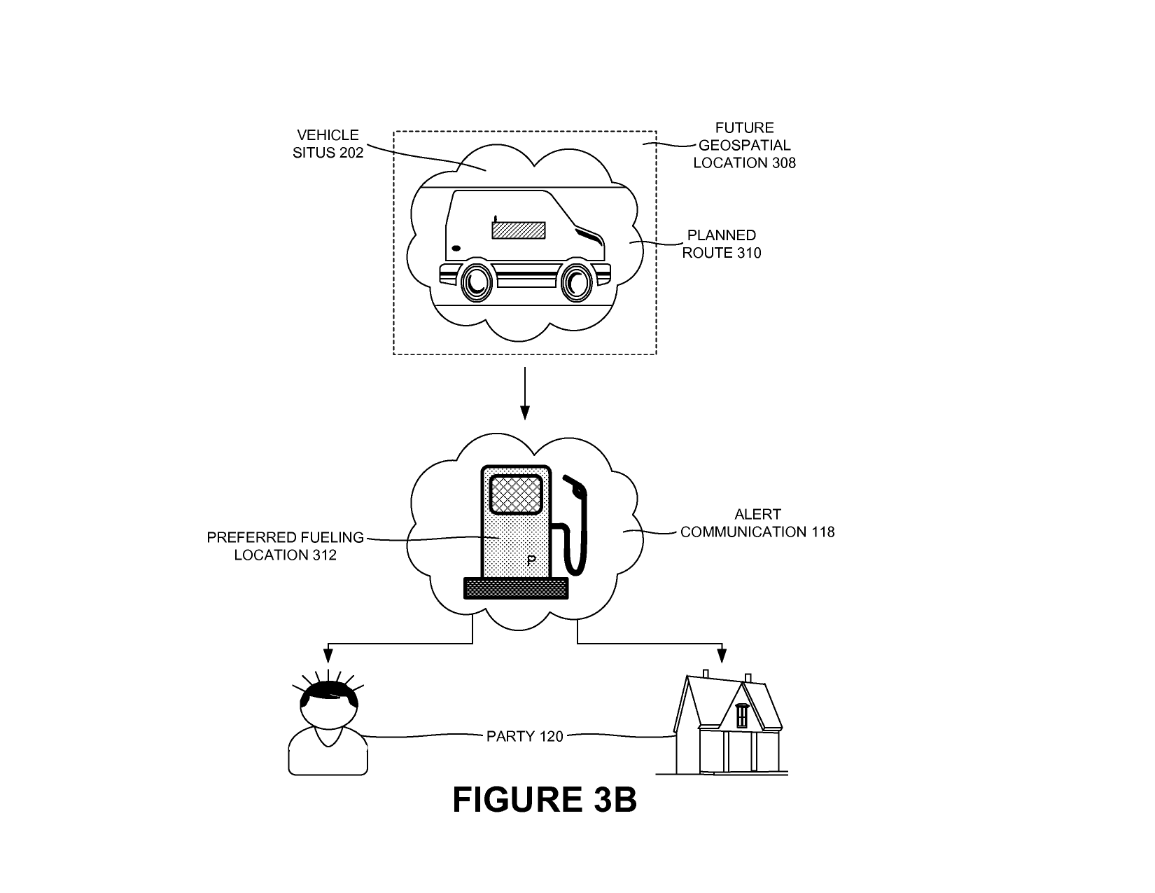

FIGS. 3A and 3B illustrate determining and generating an alert communication 118 indicative of a preferred fueling location 312 based on a future geospatial location 308 of vehicle 106, according to one or more embodiments. According to one or more illustrative embodiments, fuel card 102 may be associated with vehicle 106 equipped with a geospatial positioning device 108 and currently having a situs (e.g., vehicle situs 202) within a present geospatial location 114 (see FIG. 3A). Geospatial data 302 (302X, 302Y, 302Z etc.) may be received from the geospatial positioning device 108 and may be indicative of the present geospatial location 114 of the vehicle 106 upon use of the fuel card 102 at a fueling facility within the present geospatial location 114 (e.g., to perform a fueling transaction 412 at transaction situs 110), according to one or more exemplary embodiments.

As illustrated in FIGS. 3A and 3B, and according to one or more embodiments, the method may also comprise determining the quantity of fuel 304 purchased with the fuel card 102 at the fueling facility within the present geospatial location 114 and/or the mileage driven 306 by the vehicle 106 since a last fueling such that a preferred fueling facility 312 is determinable based on a future geospatial location 308 of the vehicle 106. An alert communication 118 may be generated and transmitted to a party 102 comprising the preferred fueling facility 312 based on the future geospatial location 308 of the vehicle 106 and/or a planned route 310 associable with the vehicle 106, according to one or more embodiments.

According to an illustrative example, the method may comprise associating a fuel card 102 with a vehicle 106 equipped with a geospatial positioning device 108 and currently having a situs within a present geospatial location 114 (e.g., vehicle situs 202). Geospatial data 302 may be received from the geospatial positioning device 108 and may be indicative of the present geospatial location 114 of the vehicle 106 upon use of the fuel card 102 at a fueling facility within the present geospatial location 114. In this exemplary embodiment, the vehicle situs 202 and the transaction situs 110 may be the same location (e.g., present geospatial location 114 of the vehicle 106).

The method may also comprise determining the quantity of fuel 304 purchased with the fuel card 102 at the fueling facility within the present geospatial location 114 and/or the mileage driven 306 by the vehicle 106 since a last fueling such that a preferred fueling facility 312 is determinable based on a future geospatial location 308 of the vehicle 106. An alert communication 118 may be generated and transmitted to a party 102 comprising the preferred fueling facility 312 based on the future geospatial location 308 of the vehicle 106 and/or a planned route 310 associable with the vehicle 106, according to one or more embodiments. It will be appreciated that a fuel efficiency of the vehicle 106 may be determined based on the quantity of fuel 304 purchased with the fuel card 102 at the fueling facility within the geospatial location 110 and/or the mileage driven 306 by the vehicle 106 since the last fueling.

FIG. 4A illustrates one or more exemplary embodiments wherein an engine idling duration 402 of the vehicle 160 during fueling may be determined based on receiving of the geospatial data 302 from the geospatial positioning device 108. The geospatial data 302 received from the geospatial positioning device 108 in the vehicle 106 may comprise an actual geographic location 404 associable with the vehicle 106 upon use of the fuel card 102 at the fueling facility within the present geospatial location 114. According to other illustrative examples, the geospatial data 302 may also comprise but may not be limited to: a fueling duration data 406 associable with the vehicle 106 upon use of the fuel card at the fueling facility within the present geospatial location 114; a fueling quantity data 408 associable with the vehicle 106 upon use of the fuel card at the fueling facility within the present geospatial location 114; and an engine run time data 410 associable with the vehicle 106 and determined based on the fueling time associable with the vehicle 106 upon use of the fuel card at the fueling facility within the present geospatial location 114 (see FIG. 4A).

FIG. 4B illustrates a validation of a fueling transaction 412 that may be determined based on receiving of the geospatial data 302 from the geospatial positioning device 108 and may comprise, but may not be limited to a fraud detection data 414 to permit an association between the vehicle 106 and the fuel card 102 to determine whether a validated vehicle is at the fueling facility at the time the fueling transaction 412 occurs and a fueling quantity data 408 to determine whether an amount of fuel purchased for the vehicle 106 is appropriate for the vehicle 106 that performs the fueling transaction 412 based on the association between the vehicle 106 and the fuel card 102.

According to additional embodiments, the validation of the fueling transaction 412 may also consider geospatial data 302 comprising a fuel type data 416 to determine whether a type of fuel purchased for the vehicle 106 is appropriate for the vehicle 106 that performs the fueling transaction 412 based on the association between the vehicle 106 and the fuel card 102, a vehicle mileage data 418 to determine if a calculated miles per gallon information is reasonable for the vehicle 106 that performs the fueling transaction 412 based on the association between the vehicle 106 and the fuel card 102, and a fueling time data 420 to determine whether the fueling transaction 412 is performed at an appropriate time (see FIG. 4B).

FIG. 5 is a table view of determining and validating authorized use of the fuel card 102 for a fueling transaction 412 of the vehicle 106 based on the transaction situs 110 and the vehicle situs 202, according to one or more embodiments. For example, according to unique identifier 104A, the vehicle 106's transaction situs 110 may be an in-network fueling facility MN12 and its vehicle situs 202 may be within two hundred (200) feet of the in-network fueling facility MN12. This distance 116 may be determined to be within the threshold limit 112 and therefore, the fueling transaction 412 may be determined to be an authorized use 502. According to another example and the unique identifier 104B, the vehicle 106's transaction situs 110 may be an out of network fueling facility OP34 and its vehicle situs may be two hundred (200) miles from the out of network fueling facility OP34. Under these factual circumstances, the distance 116 may be determined to be not within the threshold limit 112 and may be determined not to be an authorized use 502.

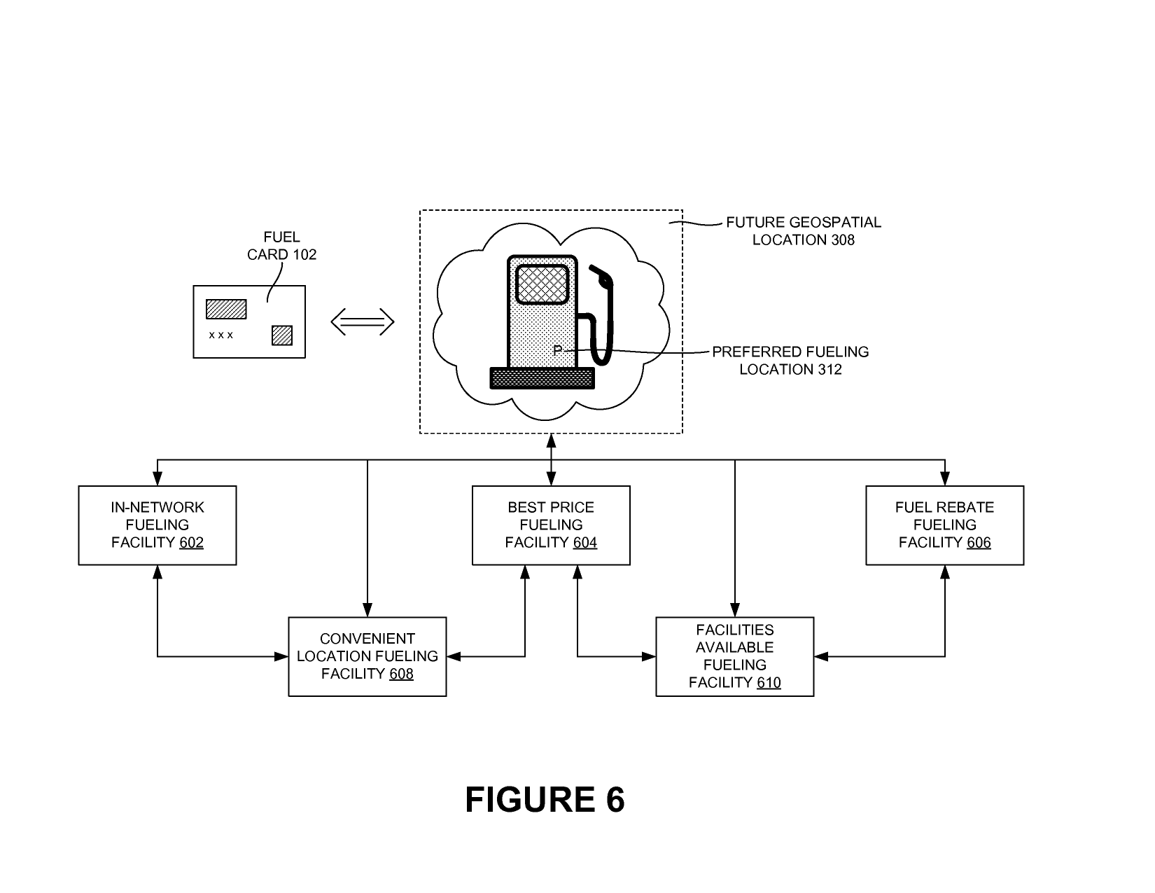

According to FIG. 6 and one or more exemplary embodiments, the preferred fueling facility 312 may be associable with a provider of the fuel card 102 such that the preferred fueling facility 312 may be determined based an in-network fueling facility 602, a best fuel price fueling facility 604, a fuel rebate fueling facility 606, a convenient location fueling facility 608, and a facilities available fueling facility 610. Others embodiments may comprise utilizing the present geospatial location 114 of the vehicle 106 received from the geospatial positioning device 108 to determine the preferred fueling facility 312 based on a plurality of fueling locations associable with the fuel card 102, a fuel type data 416 associable with the vehicle 106, a geospatial tracking data, a real-time vehicle location data, a fuel estimate data and a vehicle profile data.

It will be appreciated that, according to one or more embodiments, the preferred fueling location 312 may be determined based on the future geospatial location 308 of the vehicle 106 such that the preferred fueling location 312 is along the planned route 310 associable with the vehicle 106 (see FIG. 3B). The planned route 310 may be validated and may be associable with the vehicle 106 by utilizing the geospatial data 302 from the fueling facility within the present geospatial location 114 upon use of the fuel card 102 at the fueling facility to determine whether the vehicle 106 transgresses the planned route 310, according to one or more embodiments.

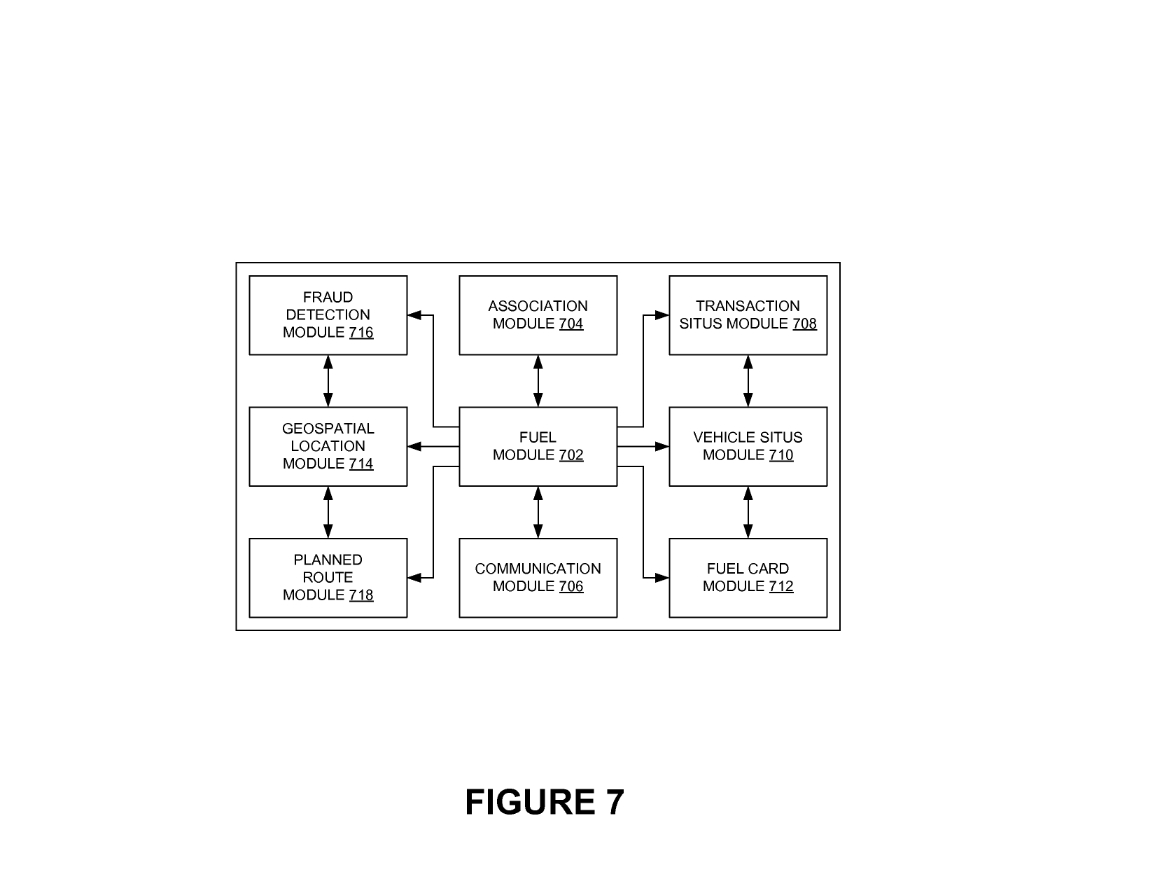

FIG. 7 is a module view wherein any of the methods and systems described herein may be implemented and/or performed, according to one or more embodiments. These modules may include, but may not be limited to: a fuel module 702, an association module 704, a communication module 706, a transaction situs module 708, a vehicle situs module 710, a fuel card module 712, a geospatial location module 714, a fraud detection module 716, and a planned route module 718. For example, a system comprising the association module 704 may be used to associate a fuel card 102 with a vehicle 106 equipped with a geospatial positioning device 108 and currently having a situs within a present geospatial location 114. A geospatial data module may be used receive a geospatial data 302 from the geospatial positioning device 108 indicative of a situs of the vehicle (e.g., vehicle situs 202) upon use of the fuel card 102 at a fueling facility within the present geospatial location 114, according to one or more embodiments.

Similarly, the fuel module 702 may be used to determine a quantity of fuel 304 purchased with the fuel card 102 at the fueling facility within the present geospatial location 114 and a mileage driven 306 by the vehicle 106 since a last fueling such that a preferred fueling facility 312 is determinable based on a future geospatial location 308 of the vehicle 106, according to one or more embodiments. According to other exemplary embodiment, a communication module may be implemented to generate an alert communication 118 to a party 120 comprising the preferred fueling facility 312 based on the future geospatial location of the vehicle 308. The alert communication 118 to a party 120 comprising the preferred fueling facility 312 may be transmitted to an on-board navigation system in the vehicle 106 that may be communicatively coupled with the geospatial positioning device 108, according to one embodiment. According to another exemplary embodiment, the alert communication 118 to a party 120 comprising the preferred fueling facility 312 may also be generated and transmitted based on a fuel tank level associable with the vehicle 106.

According to one or more embodiments, the system may comprise periodically analyzing the geospatial data 302 received from the geospatial positioning device 108 and indicative of the situs of the vehicle within the present geospatial location 114 (e.g., vehicle situs 202) and/or the geospatial data 302 received from the geospatial positioning device 108 upon use of the fuel card 102 at the fueling facility and determining the preferred fueling facility 312 based on a proximity of the preferred fueling facility 312 to the situs of the vehicle within the present geospatial location 114 (e.g., vehicle situs 202) and the future geospatial location of the vehicle 308. An algorithm may then be applied to determine whether the preferred fueling facility 312 is an in-network fueling facility 602, a best fuel price fueling facility 604, a fuel rebate fueling facility 606, a convenient location fueling facility 608, and a facilities available fueling facility 610, according to one or more embodiments. It will be appreciated that the planned route 310 may be automatically adjusted based on an application of the algorithm, according to one or more exemplary embodiments.

FIG. 8 and FIG. 9 are flow charts that illustrate a method comprising determining that a transaction associated with a purchase of a fuel of a vehicle 106 equipped with a geospatial positioning device 108 is associated with a unique identifier 104 of a fuel card 102 is disclosed. The method may comprise comparing a present geospatial location 114 of the vehicle 106 with a situs where the transaction associated with the purchase of the fuel of the vehicle 106 is determined (e.g., transaction situs 110) when a distance 116 between the vehicle 106 (e.g., vehicle situs 202) and the situs where the transaction associated with the purchase of the fuel of the vehicle occurs (e.g., transaction situs 110) is within a threshold limit 112, according to one or more embodiments.

According to other embodiments, the method may comprise comparing the present geospatial location 114 of the vehicle 106 with a situs where the transaction associated with the purchase of the fuel of the vehicle is determined (e.g., transaction situs 110) when the distance 116 between the vehicle 106 and the situs where the transaction associated with the purchase of the fuel of the vehicle (e.g., transaction situs 110) is outside the threshold limit 112, according to one illustrative example. According to another exemplary embodiment, the method may also comprise generating an alert communication 118 to a party based on a transgression of the vehicle from the threshold limit 110.

FIG. 9 also illustrates determining the quantity of fuel 304 purchased with the fuel card 102 at the fueling facility within the present geospatial location 114 and/or the mileage driven 306 by the vehicle 106 since a last fueling such that a preferred fueling facility 312 is determinable based on a future geospatial location 308 of the vehicle 106. An alert communication 118 may be generated and transmitted to a party 102 comprising the preferred fueling facility 312 based on the future geospatial location 308 of the vehicle 106 and/or a planned route 310 associable with the vehicle 106, according to one or more embodiments.

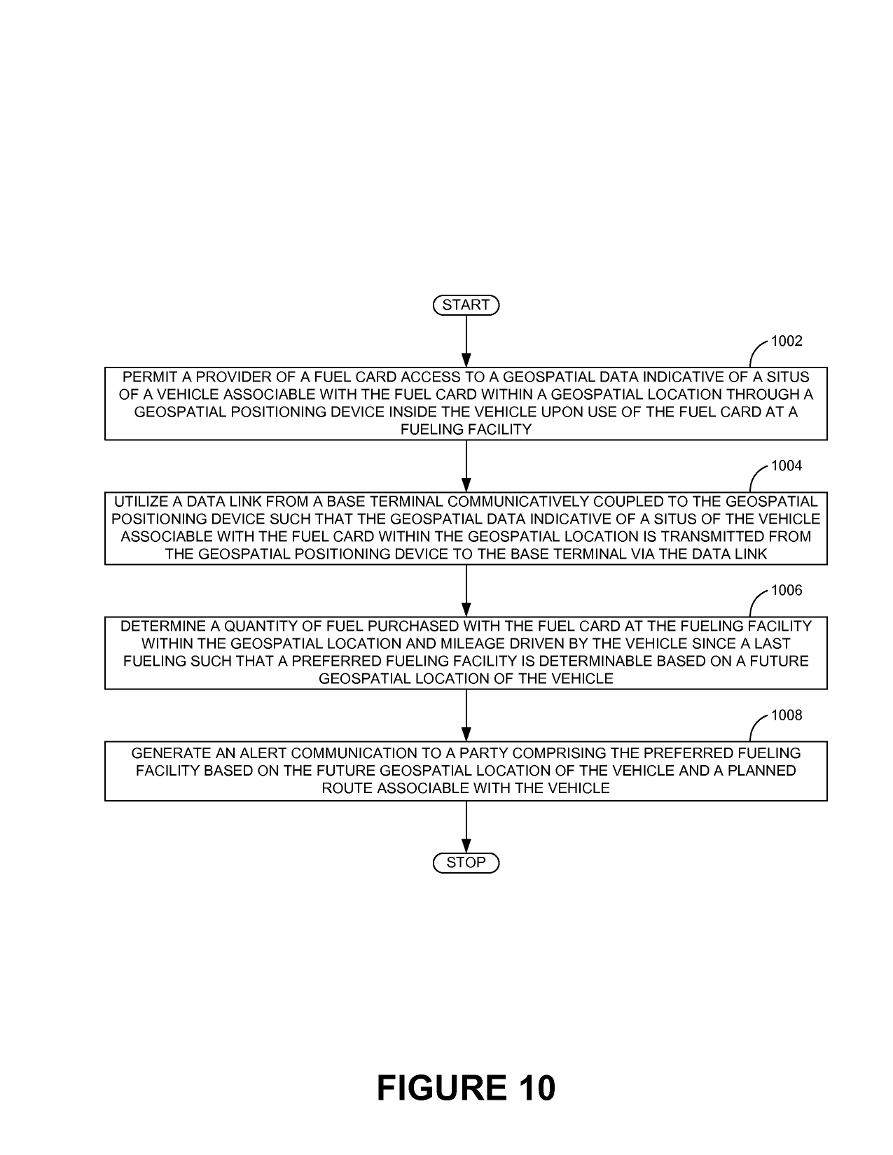

As illustrated by FIG. 10, the method, according to one or more embodiments, may comprise permitting a provider of a fuel card 102 access to a geospatial data 302 indicative of a situs of a vehicle (e.g., vehicle situs 202) associable with the fuel card 102 within a present geospatial location 114 through a geospatial positioning device 108 inside the vehicle 106 upon use of the fuel card 102 at a fueling facility. The method may further comprise utilizing a data link from a base terminal communicatively coupled to the geospatial positioning device 108 such that the geospatial data 302 indicative of a situs of the vehicle (e.g., vehicle situs 202) associable with the fuel card 102 within the geospatial location 114 is transmitted from the geospatial positioning device 108 to the base terminal via the data link, according to one or more illustrative embodiments.

According to one embodiment, the method may involve determining the quantity of fuel 304 purchased with the fuel card 102 at the fueling facility within the present geospatial location 114 and/or a mileage driven 306 by the vehicle 106 since a last fueling such that a preferred fueling facility 312 is determinable based on a future geospatial location 308 of the vehicle 106. An alert communication 118 may be generated to a party 120 comprising the preferred fueling facility 312 based the future geospatial location 308 of the vehicle 106 and/or a planned route 310 associable with the vehicle 106, according to another embodiment.

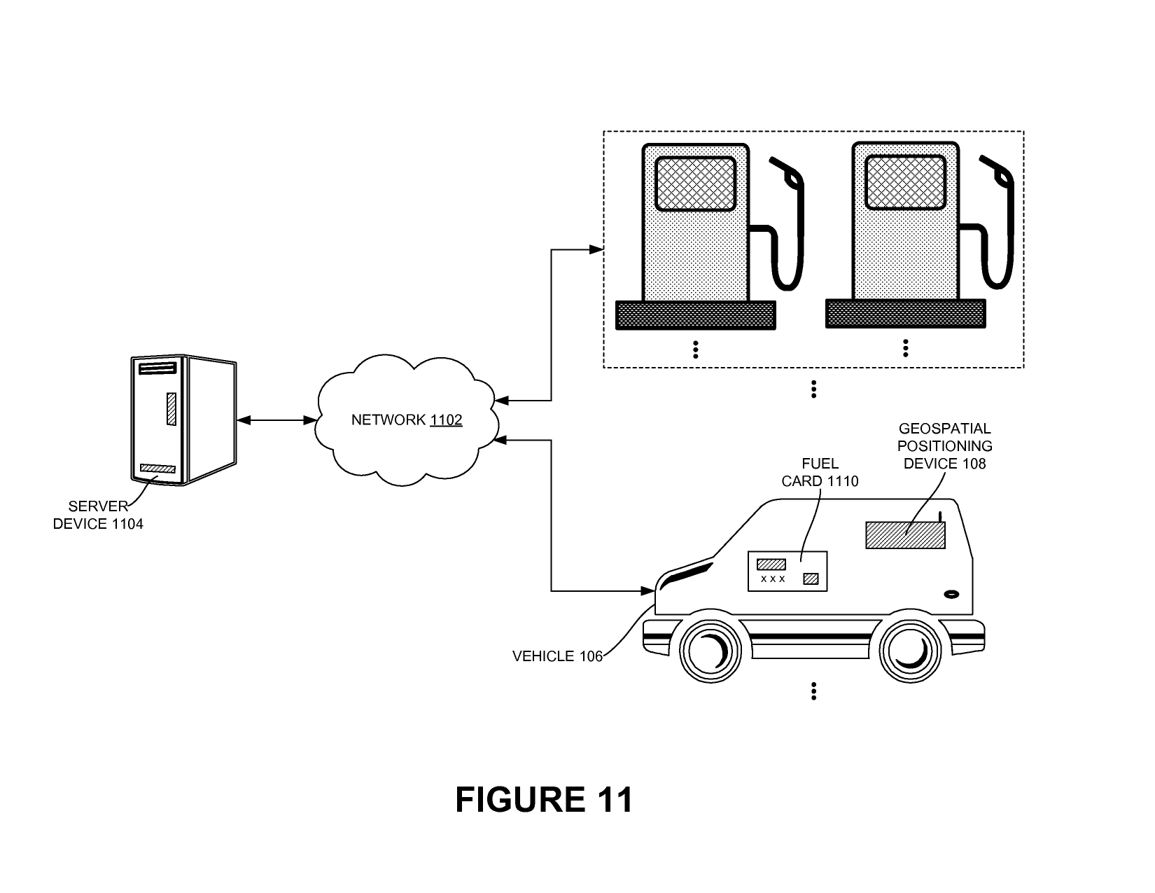

The geospatial data 302 indicative of a situs of a vehicle 106 (e.g., vehicle situs 202) within the present geospatial location 114 may comprise a telemetry data associated with the vehicle 106 such that the telemetry data may be received on a server device 1104 (see FIG. 11) from the geospatial positioning device 108, according to one or more embodiments. The use of the fuel card 102 at the fueling facility may also be compared with a plurality of other fueling facilities along the planned route 310 and/or a plurality of preferred fueling facilities 312 to determine whether a variance is beyond a threshold limit 112, according to one or more exemplary embodiments.

An emergency fueling communication may be generated to the party 120 upon determination of a distance 116 between the fueling facility where the fuel card 102 was last used and the preferred fueling facility 312 such that the planned route 310 may be automatically adjusted to account for a fuel tank level associable with the vehicle 106, according to one or more embodiments. The alert communication 118 comprising the preferred fueling facility 312 may indicate whether the preferred fueling facility 312 is at least one of an in-network fueling facility 602, a best fuel price fueling facility 604, a fuel rebate fueling facility 606, a convenient location fueling facility 608, and/or a facilities available fueling facility 610, according to one or more embodiments (see FIG. 6).

The alert communication 118 comprising the preferred fueling facility 312 may be transmitted via a short message service, an electronic mail, an on-board mobile data terminal, an on-board navigation system, and/or a mobile communication system, according to one or more embodiments. It will also be appreciated that the fuel card 102 may be associated with a driver 204 of the vehicle 106, according to one exemplary embodiment.

For example, a fleet management company and provide a fuel card 102 to one or more of its drivers 204 for fueling their vehicle 106 while they are on a planned route 310. Based on the driver's use of the fuel card 102 at a fueling location and planned route 310, one or more preferred “in-network” fueling facilities may be provided to the driver 204 via an onboard vehicle navigation system. The GPS data derived from the driver's vehicle 106 may indicate that the driver 204 is driving along Highway 405 in Los Angeles. However, the fuel card 102's billing data may indicate that the fuel card 102 was last used to purchase fuel an hour ago in Las Vegas at an “out-of-network” fueling facility. Under these circumstances, an alert communication may be transmitted to the provider of the fuel card (in this case, the fleet management company) to alert them of possible fraud and/or unauthorized use of the fuel card associable with the driver of the vehicle (see FIG. 5).

Although the present embodiments have been described with reference to specific example embodiments, it will be evident that various modifications and changes may be made to these embodiments without departing from the broader spirit and scope of the various embodiments. For example, the various devices (e.g., the server device 1104), modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry). For example, data transmission technologies, geospatial positioning devices, and devices other than ones employing GPS technology (e.g., RFID, RTLS, OEM telematics, location detection based on cell phone towers, electromagnetic waves, optical emissions, infrared, radar, sonar, radio, Bluetooth™ etc.) may be used to transmit telemetry data 106 for the purposes of the invention described herein, according to one or more exemplary embodiments.

Particularly, several modules as illustrated in FIG. 7 may be employed to execute the present embodiments. The fuel module 702, the association module 704, the communication module 706, the transaction situs module 708, the vehicle situs module 710, the fuel card module 712, the geospatial location module 714, the fraud detection module 716, the planned route module 718, and all other modules of FIGS. 1-12 may be enabled using software and/or using transistors, logic gates, and electrical circuits (e.g., application specific integrated ASIC circuitry) such as a security circuit, a recognition circuit, a dynamic landmark circuit, an ignition event circuit, a store circuit, a transform circuit, an ICE circuit, and other circuits.

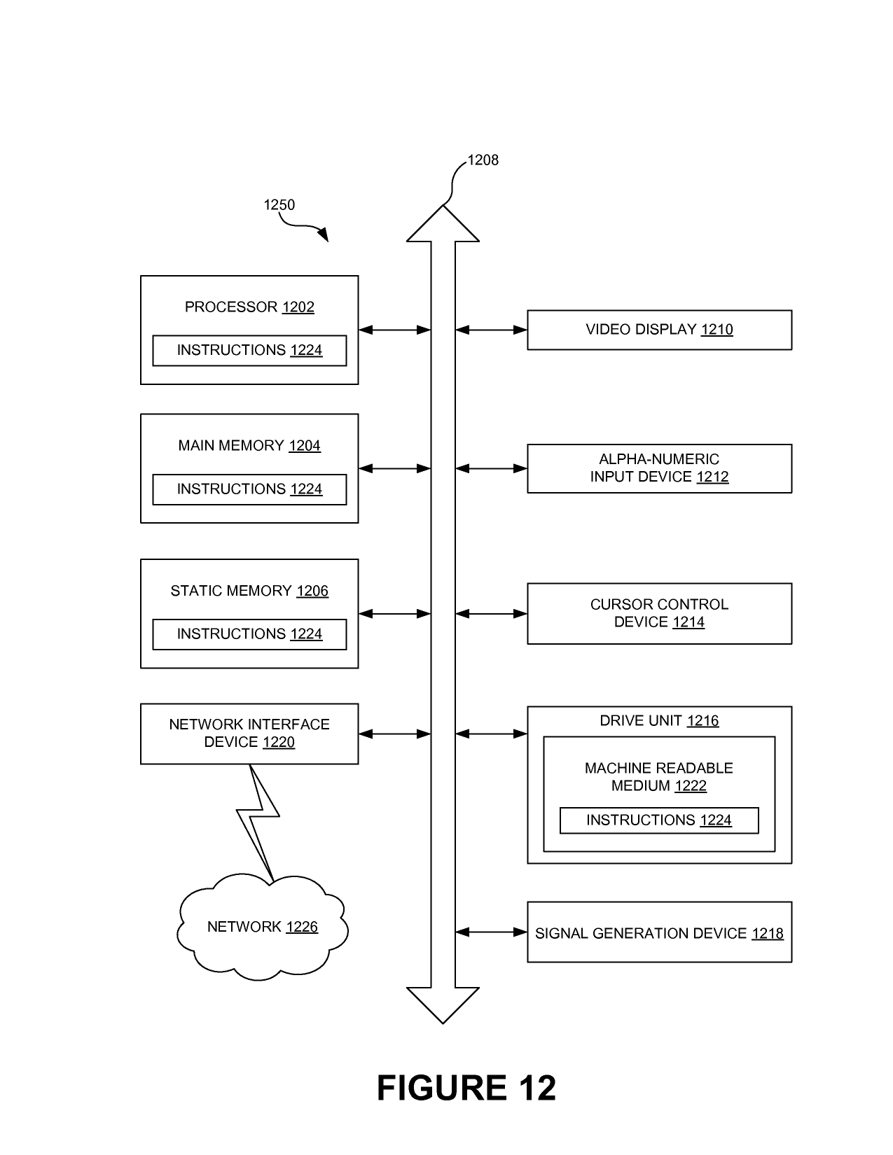

FIG. 12 may indicate a personal computer and/or the data processing system in which one or more operations disclosed herein may be performed. The processor 1202 may be a microprocessor, a state machine, an application specific integrated circuit, a field programmable gate array, etc. (e.g., Intel® Pentium® processor, 620 MHz ARM1176®, etc.). The main memory 1204 may be a dynamic random access memory, a non-transitory memory, and/or a primary memory of a computer system. The static memory 1206 may be a hard drive, a flash drive, and/or other memory information associated with the data processing system. The bus 1208 may be an interconnection between various circuits and/or structures of the data processing system. The video display 1210 may provide graphical representation of information on the data processing system.

The alpha-numeric input device 1212 may be a keypad, a keyboard, a virtual keypad of a touchscreen and/or any other input device of text (e.g., a special device to aid the physically handicapped). The cursor control device 1214 may be a pointing device such as a mouse. The drive unit 1216 may be the hard drive, a storage system, and/or other longer term storage subsystem. The signal generation device 1218 may be a bios and/or a functional operating system of the data processing system. The network interface device 1220 may be a device that performs interface functions such as code conversion, protocol conversion and/or buffering required for communication to and from the network 1226. The machine readable medium 1228 may provide instructions on which any of the methods disclosed herein may be performed. The instructions 1224 may provide source code and/or data code to the processor 1202 to enable any one or more operations disclosed herein.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method comprising:
determining that a transaction associated with a purchase of a fuel of a vehicle equipped with a geospatial positioning device is associated with a unique identifier of a fuel card;
comparing a present geospatial location of the vehicle with a situs where the transaction associated with the purchase of the fuel of the vehicle is determined:
when a distance between the vehicle and the situs where the transaction associated with the purchase of the fuel of the vehicle occurs is within a threshold limit;
when the distance between the vehicle and the situs where the transaction associated with the purchase of the fuel of the vehicle is outside the threshold limit; and
generating an alert communication to a party based on a transgression of the vehicle from the threshold limit.

2. The method of claim 1 further comprising:
associating the fuel card with at least one of a driver of the vehicle and the vehicle equipped with the geospatial positioning device and currently having the situs within the present geospatial location;
verifying an authorized use of the fuel card upon initiation of the transaction associated with the purchase of the fuel of the vehicle;
generating an alert communication to the party if the transaction associated with the purchase of a fuel of the vehicle is not the authorized use; and
analyzing a geospatial data received from the vehicle equipped with the geospatial positioning device to locate the situs of the vehicle within the present geospatial location.

3. A method comprising:
associating a fuel card with a vehicle equipped with a geospatial positioning device and currently having a situs within a present geospatial location;
receiving a geospatial data from the geospatial positioning device indicative of the present geospatial location of the vehicle upon use of the fuel card at a fueling facility within the present geospatial location;
determining at least one of a quantity of fuel purchased with the fuel card at the fueling facility within the present geospatial location and a mileage driven by the vehicle since a last fueling such that a preferred fueling facility is determinable based on a future geospatial location of the vehicle; and
generating an alert communication to a party comprising the preferred fueling facility based on at least one of a future geospatial location of the vehicle and a planned route associable with the vehicle.

4. The method of claim 3 wherein a fuel efficiency of the vehicle is determined based on at least one of the quantity of fuel purchased with the fuel card at the fueling facility within the geospatial location and the mileage driven by the vehicle since the last fueling.

5. The method of claim 3 wherein an engine idling duration of the vehicle during fueling is determined based on receiving of the geospatial data from the geospatial positioning device comprising:
an actual geographic location associable with the vehicle upon use of the fuel card at the fueling facility within the present geospatial location;
a fueling duration data associable with the vehicle upon use of the fuel card at the fueling facility within the present geospatial location;
a fueling quantity data associable with the vehicle upon use of the fuel card at the fueling facility within the present geospatial location; and
an engine run time data associable with the vehicle and determined based on the fueling time associable with the vehicle upon use of the fuel card at the fueling facility within the present geospatial location.

6. The method of claim 3 wherein validation of a fueling transaction is determined based on receiving of the geospatial data from the geospatial positioning device comprising:
a fraud detection data to permit an association between the vehicle and the fuel card to determine whether a validated vehicle is at the fueling facility at the time the fueling transaction occurs;
a fueling quantity data to determine whether an amount of fuel purchased for the vehicle is appropriate for the vehicle that performs the fueling transaction based on the association between the vehicle and the fuel card;
a fuel type data to determine whether a type of fuel purchased for the vehicle is appropriate for the vehicle that performs the fueling transaction based on the association between the vehicle and the fuel card;
a vehicle mileage data to determine if a calculated miles per gallon information is reasonable for the vehicle that performs the fueling transaction based on the association between the vehicle and the fuel card; and
a fueling time data to determine whether the fueling transaction is performed at an appropriate time.

7. The method of claim 3 wherein the preferred fueling facility is associable with a provider of the fuel card such that the preferred fueling facility is determined based on at least one of an in-network fueling facility, a best fuel price fueling facility, a fuel rebate fueling facility, a convenient location fueling facility, and a facilities available fueling facility.

8. The method of claim 7 further comprising utilizing the present geospatial location of the vehicle received from the geospatial positioning device to determine the preferred fueling facility based on at least one of a plurality of fueling locations associable with the fuel card, a fuel type data associable with the vehicle, a geospatial tracking data, a real-time vehicle location data, a fuel estimate data and a vehicle profile data.

9. The method of claim 8 further comprising determining the preferred fueling location based on the future geospatial location of the vehicle such that the preferred fueling location is along the planned route associable with the vehicle.

10. The method of claim 9 further comprising validating the planned route associable with the vehicle by utilizing the geospatial data from the fueling facility within the present geospatial location upon use of the fuel card at the fueling facility to determine whether the vehicle transgresses the planned route.

11. A system comprising:
an association module to associate a fuel card with a vehicle equipped with a geospatial positioning device and currently having a situs within a present geospatial location;
a geospatial data module to receive a geospatial data from the geospatial positioning device indicative of a situs of the vehicle upon use of the fuel card at a fueling facility within the present geospatial location;
a fuel module to determine at least one of a quantity of fuel purchased with the fuel card at the fueling facility within the present geospatial location and a mileage driven by the vehicle since a last fueling such that a preferred fueling facility is determinable based on a future geospatial location of the vehicle; and
a communication module to generate an alert communication to a party comprising the preferred fueling facility based on the future geospatial location of the vehicle.

12. The system of claim 11 wherein the alert communication to a party comprising the preferred fueling facility is transmitted to an on-board navigation system in the vehicle that is communicatively coupled with the geospatial positioning device.

13. The system of claim 12 further comprising generating the alert communication to a party comprising the preferred fueling facility based on a fuel tank level associable with the vehicle.

14. The system of claim 11 further comprising:
periodically analyzing at least one of the geospatial data received from the geospatial positioning device and indicative of the situs of the vehicle within the present geospatial location and the geospatial data received from the geospatial positioning device upon use of the fuel card at the fueling facility;
determining the preferred fueling facility based on a proximity of the preferred fueling facility to at least one of the situs of the vehicle within the present geospatial location and the future geospatial location of the vehicle;
applying an algorithm to determine whether the preferred fueling facility is at least one of an in-network fueling facility, a best fuel price fueling facility, a fuel rebate fueling facility, a convenient location fueling facility, and a facilities available fueling facility; and
automatically adjusting a planned route based on an application of the algorithm.

15. The system of claim 14 further comprising determining the preferred fueling facility based on at least one of a plurality of fueling locations associable with the fuel card, a fuel type data associable with the vehicle, a geospatial tracking data, a real-time vehicle location data, a fuel estimate data and a vehicle profile data.

16. The system of claim 14 further comprising determining the preferred fueling facility based on a previous use of the fuel card at an another fueling facility such that the planned route associable with the vehicle is automatically adjusted based on at least one of an estimated miles per gallon and a mileage driven since the previous use of the fuel card at the another fueling facility.

17. A method comprising:
permitting a provider of a fuel card access to a geospatial data indicative of a situs of a vehicle associable with the fuel card within a present geospatial location through a geospatial positioning device inside the vehicle upon use of the fuel card at a fueling facility;
utilizing a data link from a base terminal communicatively coupled to the geospatial positioning device such that the geospatial data indicative of a situs of the vehicle associable with the fuel card within the geospatial location is transmitted from the geospatial positioning device to the base terminal via the data link;
determining at least one of a quantity of fuel purchased with the fuel card at the fueling facility within the present geospatial location and a mileage driven by the vehicle since a last fueling such that a preferred fueling facility is determinable based on a future geospatial location of the vehicle; and
generating an alert communication to a party comprising the preferred fueling facility based on at least one of the future geospatial location of the vehicle and a planned route associable with the vehicle.

18. The method of claim 17 wherein the geospatial data indicative of a situs of a vehicle within the present geospatial location comprises a telemetry data associated with the vehicle such that the telemetry data is received on a server device from the geospatial positioning device.

19. The method of claim 17 further comprising comparing the use of the fuel card at the fueling facility with at least one of a plurality of other fueling facilities along the planned route and a plurality of preferred fueling facilities to determine whether a variance is beyond a threshold limit.

20. The method of claim 17 further comprising generating an emergency fueling communication to the party upon determination of a distance between the fueling facility where the fuel card was last used and the preferred fueling facility such that the planned route is automatically adjusted to account for a fuel tank level associable with the vehicle.

21. The method of claim 17 wherein the alert communication comprising the preferred fueling facility indicates whether the preferred fueling facility is at least one of an in-network fueling facility, a best fuel price fueling facility, a fuel rebate fueling facility, a convenient location fueling facility, and a facilities available fueling facility.

22. The method of claim 17 wherein the alert communication comprising the preferred fueling facility is transmitted via at least one of a short message service, an electronic mail, an on-board mobile data terminal, an on-board navigation system, and a mobile communication system.

23. The method of claim 17 wherein the fuel card is associated with a driver of the vehicle.
